(19) United States
(12) Patent Application Publication
(10) Pub. No.: US 2002/0156597 A1
(43) Pub. Date: Oct. 24, 2002

(54) Inspection report generation software

(76) Inventor: Arnold J. Kornowski JR., Hartford, WI (US)

Correspondence Address: Donald J. Ersler, 725 Garvens Avenue, Brookfield, WI, 53005, US

(21) Appl. No.: 09/839,503

(22) Filed: Apr. 20, 2001

(51) Int. Cl. G06F 15/00; G06F 17/18; G06F 101/14

(52) U.S. Cl. 702/179

(57) ABSTRACT

Inspection report generating software reads a CMM data file, rearranges the raw data, reformats the raw data into readable columns, allows a geometric tolerance control frame to be generated for each dimension, and provides the ability to perform statistical analysis on a group of parts. An operator may create an inspection report spread sheet by clicking on a button. The geometric tolerance control frames may be inserted into the inspection spread sheet by marking a cell of a specific dimension. The first, second, and/or third datums are entered with any appropriate material modifiers. A user may create a capability study spread sheet by clicking on a button. The capability study spread sheet allows a user to perform statistical analysis on a group of parts.

### BACKGROUND OF THE INVENTION

1. Field of the Invention

The present invention relates generally to coordinate measuring machines and more specifically to inspection report generation software which takes a data file from a coordinate measuring machine and converts thereof into a meaningful and readable inspection report.

2. Discussion of the Prior Art

Coordinate measuring machines (CMM) store numeric dimensional information taken from the inspection of a particular piece part. The numeric information is stored in an electronic form as a data file and may be downloaded to an electronic storage media. The numeric dimension information may also be printed on a sheet of paper. The printed output of the data file is difficult to read as related to how a particular piece part was measured relative to the tolerances on its drawing. The printed output also does not provide geometric tolerance control frames and how the dimensions of a particular piece part compared to the tolerances in the geometric tolerance control frames.

Accordingly, there is a clearly felt need in the art for inspection generating software which provides geometric tolerance control frames, the tolerances of each dimension, the actual piece part measurement results for each dimension, and any relevant notes about a particular dimension.

### SUMMARY OF THE INVENTION

The present invention provides an inspection report generating software which provides a readable format. The inspection report generating software reads a CMM data file, rearranges the raw data, reformats the raw data into readable columns, allows a geometric tolerance control frame to be generated for each dimension, and provides the ability to perform statistical analysis on a group of parts. Preferably, a main menu provides an inspection report button, a capability study button, and a geometric tolerance control frame button.

Clicking on the inspection report button allows an operator to create a new inspection report on a spread sheet. The geometric tolerance control frames may be inserted into the inspection spread sheet by marking a cell of a specific dimension and clicking on the geometric tolerance control frame button. The applicable type of geometric feature is chosen such as parallelism, concentricity, etc. Next, the first, second, and/or third datums are entered with any appropriate material modifiers.

Clicking on the capability study button allows an operator to statistically analyze a group of parts. First, the open a new capability study button is clicked which provides a capability spread sheet for calculating statistical functions such as CP, CPK, Average, Sigma, and others. Depressing the additional parts to the capability study button allows a group of parts to be entered into the capability study. The capability spread sheet preferably organizes a specific dimension of each part in a single column.

The inspection report generating software may be installed on a CMM computer, or data file(s) from the CMM computer may be transferred to a stand alone computer where the inspection report generating software is installed.

Accordingly, it is an object of the present invention to provide inspection report generating software which allows the data file from a CMM to be placed into a readable format.

It is a further object of the present invention to provide inspection report generating software which allows geometric tolerancing control frames to be displayed adjacent a particular dimension in an inspection report.

Finally, it is another object of the present invention to provide inspection report generating software which allows a group of parts to be statistically analyzed.

These and additional objects, advantages, features and benefits of the present invention will become apparent from the following specification.

### BRIEF DESCRIPTION OF THE DRAWINGS

FIG. 1 is a computer screen view of a main menu of an inspection report generating software program in accordance with the present invention.

FIG. 2 is a computer screen view of an inspection report menu of an inspection report generating software program in accordance with the present invention.

FIG. 3 is a computer screen view of a pop-up window for receiving the file number of an existing report of an inspection report generating software program in accordance with the present invention.

FIG. 4 is a computer screen view of a process capability menu of an inspection report generating software program in accordance with the present invention.

FIG. 5 is a computer screen view of a geometric tolerancing main menu of an inspection report generating software program in accordance with the present invention.

FIG. 6 is a computer screen view of a second portion of a geometric tolerancing main menu of an inspection report generating software program in accordance with the present invention.

FIG. 7 is a computer screen view of a material modifiers menu of an inspection report generating software program in accordance with the present invention.

FIG. 8 is a computer screen view of a data page of an inspection report spread sheet of an inspection report generating software program in accordance with the present invention.

FIG. 9 is a computer screen view of a report page of an inspection report spread sheet of an inspection report generating software program in accordance with the present invention.

FIG. 10 is a sample of geometric tolerance control frames insertable into a report page of an inspection report spread sheet of an inspection report generating software program in accordance with the present invention.

FIG. 11 is a computer screen view of a capability study, study page of inspection report generating software program in accordance with the present invention.

FIG. 12 is a computer screen view of a capability study data page of inspection report generating software program in accordance with the present invention.

FIG. 13 is a bottom portion of a study page of a capability study of inspection report generating software program in accordance with the present invention.

### DETAILED DESCRIPTION OF THE PREFERRED EMBODIMENTS

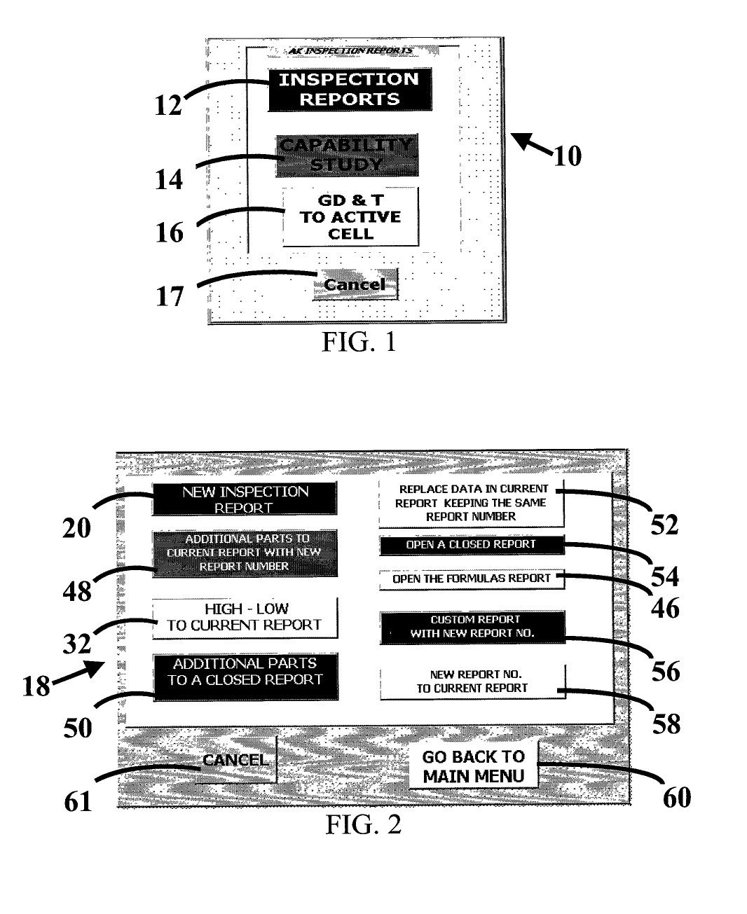

With reference now to the drawings, and particularly to FIG. 1, there is shown a computer screen view of inspection report generating software. The inspection report generating software reads a CMM data file, rearranges the raw data, reformats the raw data into readable columns, allows a geometric tolerance control frame to be generated for each dimension, and provides the ability to perform statistical analysis on a group of parts. The inspection report generating software is preferably created in the visual basic programming language, but other programming languages may also be used. Preferably, a main menu 10 provides an inspection report button 12, a capability study button 14, and a geometric tolerance control frame button 16. With reference to FIG. 2, clicking on the inspection report button 12 provides an inspection report menu 18.

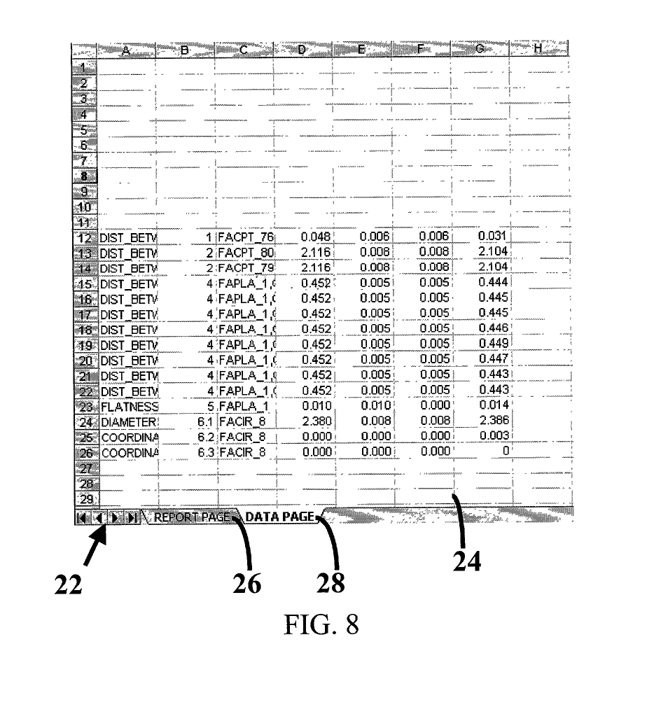

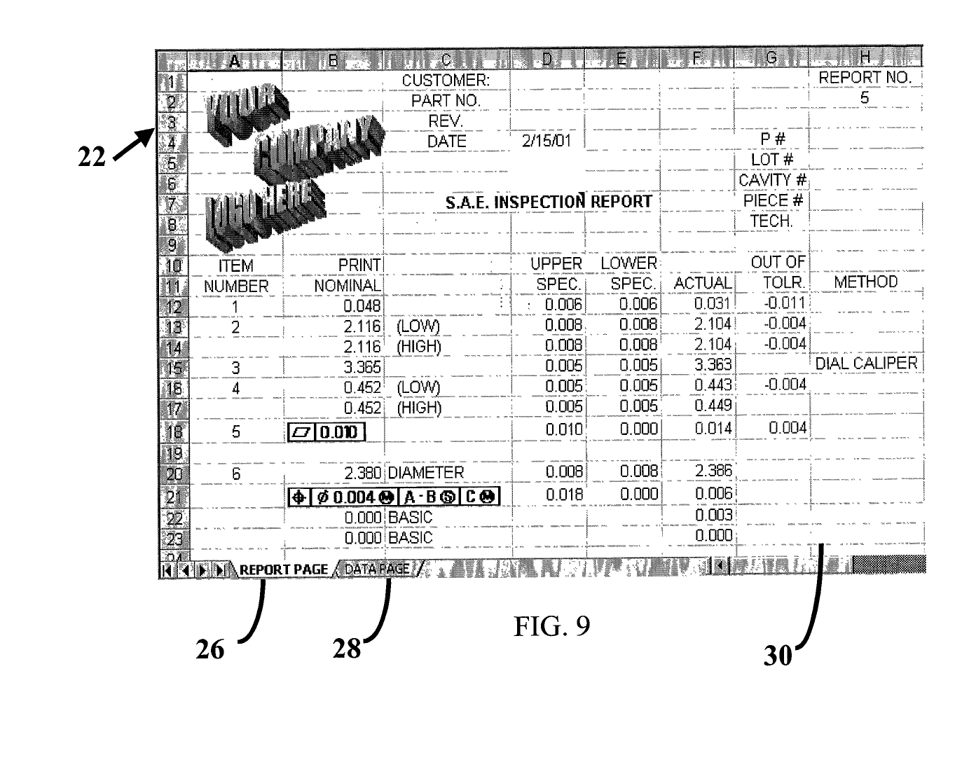

With reference to FIGS. 8 and 9, an inspection spread sheet 22 may be created by clicking on the new inspection report button 20. The inspection spread sheet 22 preferably comes up in Microsoft Excel. However, other spread sheet programs may also be used. The inspection report generating software will open a previously saved text file generated by a Coordinate Measuring Machine (CMM). The inspection report generating software (inspection software) will remove excess lines and text from the CMM text file; then rearrange the values of the dimensions according to the numbers designated on a blue print of a piece part. The inspection software provides two spread sheet formats for the rearranged data. The first format is a data page 24 which is shown in FIG. 8. The second format is a report page 30 which is shown in FIG. 9. The inspection software allows toggling between the report page 30 and the data page 24 by clicking either the report page tab 26 or the data page tab 28 on the bottom left corner of the inspection report spread sheet 22. The operator exits the data page 24 or the report page 30 by clicking file on the menu and then close just like any other windows program.

Preferably, the data page 24 contains a series of columns which describe a particular attribute of each item number. Column A contains the type of geometric dimensioning features. Column B contains the item number of a dimension provided on a blue print of piece part. Multiple readings for item 4 may be later condensed to a range. Column C contains measurement points provided in a CMM data file. Column D contains the nominal value of a particular dimension. Column E contains the upper tolerance limit of the dimension and Column F contains the lower tolerance limit of the dimension or feature size. Column G discloses the actual measured dimension of the piece part.

The report page 30 is preferably identified by filling in a cell for customer, part number, and revision. Further, the report page 30 may also be modified by the operator for content. An area for inserting a company logo is formed on in an upper left corner of the report page 30. The report page 30 preferably contains a series of columns which describe a particular attribute of each item number. Column A contains the Item Number which corresponds to the identification of a dimension provided on a blue print of a piece part. Column B contains the nominal value of a particular dimension. Column D contains the upper tolerance limit of the dimension and Column E contains the lower tolerance limit of the dimension. Column F discloses the actual measured dimension of the piece part. Column G discloses if the actual measured dimension is out of tolerance and by how much.

Each cell in Column A of the report page 30 contains a function that looks at the respective cell in Column B of the data page 24 to determine what value to insert therein. Each cell in Column B of the report page 30 contains a function that looks at the respective cell in Column D of the data page 24 to determine what value to insert therein. Each cell in Column C of the report page 30 contains a function that looks at the respective cells in Columns A, E, and F of the data page 24 to determine if a description should be inserted therein such as RADIUS BASIC, DIAMETER, FLATNESS, etc. Each cell in Column D of the report page 30 contains a function that looks at the respective cell in Column E of the data page 24 to determine what value to insert therein, if any.

Each cell in Column E of the report page 30 contains a function that looks at the respective cell in Column F of the data page 24 to determine what value to insert therein, if any. If the cell in Columns E or F of the data page 24 contains a zero, then the respective cell on the report page 30 is left blank. Each cell in Column F of the report page 30 contains a formula that looks at the respective cell in Column G of the data page 24 to determine what value to insert therein. A formula in Column G looks at the cells of Columns B, D, E & F of the report page 30 to determine if the measured value is out of tolerance. If the value is out of tolerance, the value will be printed in red on the report page. Preferably, the inspection software automatically inserts the present date in cell D4 of the report page 30 and a consecutive report number. The inspection software looks at the saved files and adds 1 to the last file saved and inserts the value in cell H2 of the report page 30.

The operator has the option to condense the inspection report 30 by clicking on the high-low button 32. For example cells 15D-22D on the data page 24 contain the same dimension measured multiple times. The high-low feature will list only the highest and lowest measurement for any dimension that was checked by the CMM more then one time. For example, the width of a part may be checked multiple places to show the variation of that feature more accurately.

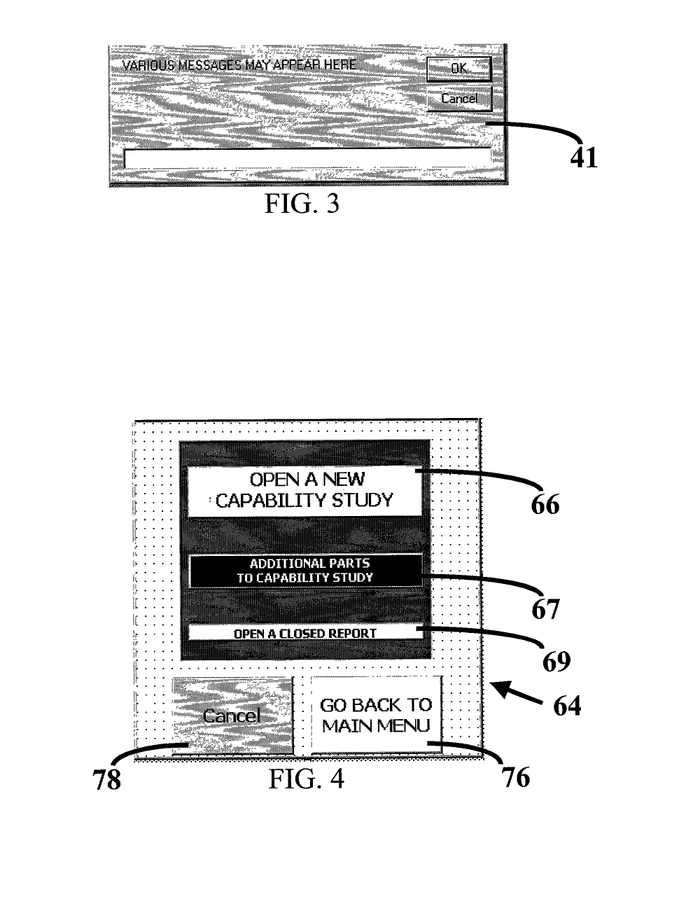

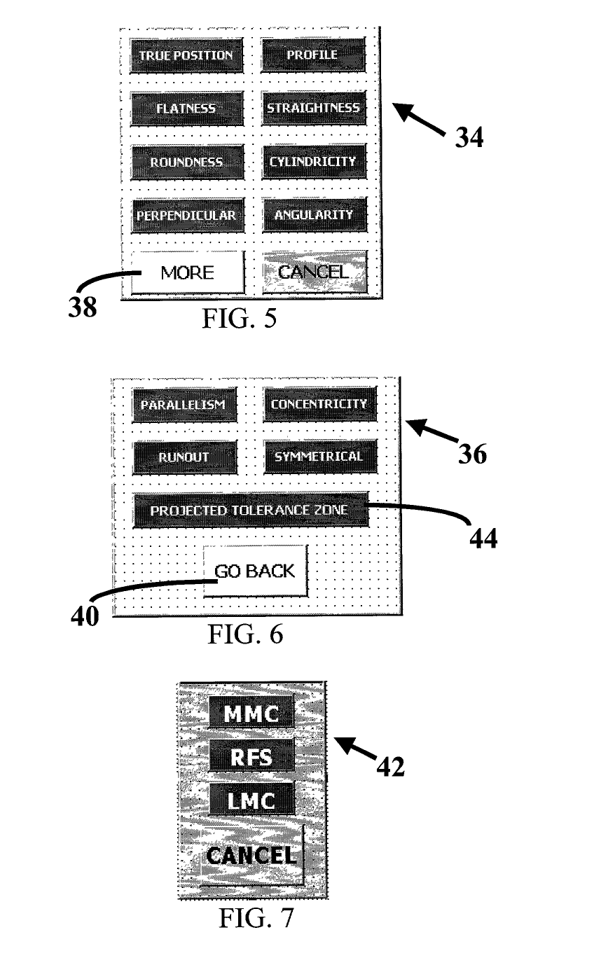

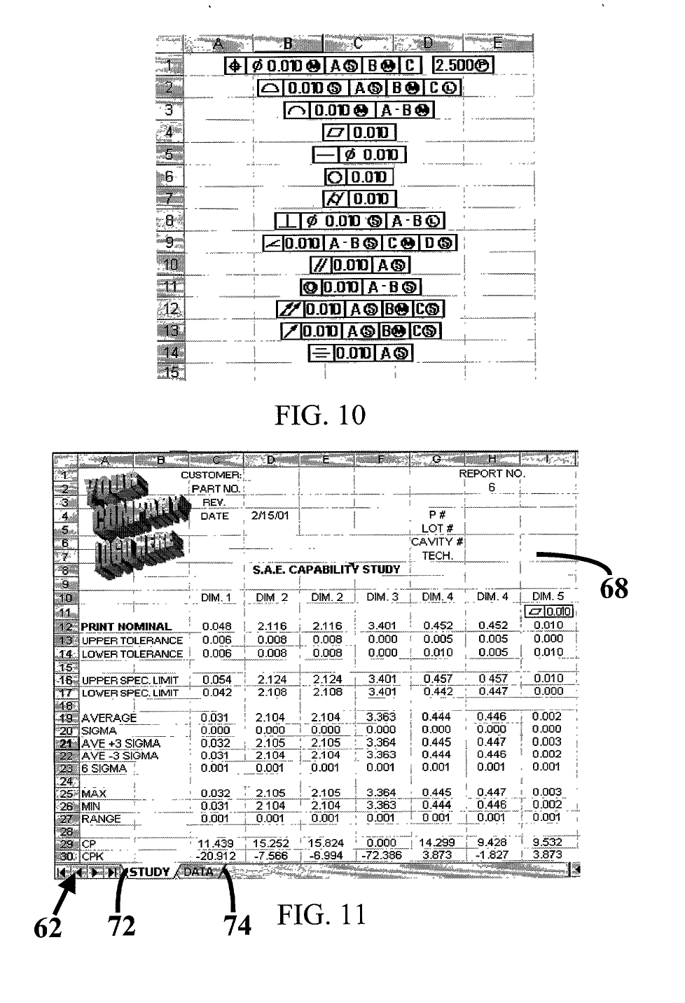

Geometric tolerances control frames may be added to an inspection report by clicking on the GD & T button 16. Samples of geometric tolerance feature frames are shown in FIG. 10. The Geometric tolerancing main menu 34 will be displayed as shown in FIG. 5 by clicking button 16. The geometric tolerancing main menu 34 displays several geometric tolerancing features. Other geometric tolerancing features are displayed in a second geometric tolernacing menu 36 by clicking on the more button 38. The operator may go back to geometric tolerancing main menu by clicking on the go back button 40. Values are inserted into feature control frames through an automatic pop-up window 41 similar to that shown in FIG. 3. With reference to FIG. 7, material modifiers are preferably added to feature control frames through a material modifier menu 42. The material modifier menu 42 is accessed automatically when the operator chooses to build a geometric tolerance control frame using the supplied menus. Depressing the open formulas button 46 displays a list of geometric tolerancing formulas which may be copied and pasted as required by an operator.

Additional parts measured on a CMM may be added to a current inspection report by clicking on an additional parts button 48. The current inspection report will be given a new report number. Additional parts measured on a CMM may be added to a previously created inspection report by clicking on an additional parts button 50. The operator enters the report number on a pop-up window 41. A current report may be edited by clicking on the replace data button 52. The current report will retain its identifying number. The new data will be first inserted into the data page 24 of the inspection report. The report page tab 28 is depressed to obtain the report page. Each cell pulls data on the data page 24 and inserts it into the report page 30.

A previously saved inspection report may be accessed by clicking on the closed report button 54. The report number is entered into an automatic pop-up window 41 as shown in FIG. 3. A report with manually entered data may be created by clicking on the custom report button 56. The inspection report will have a basic template similar to that shown in FIG. 9. A report number and the date are preferably automatically assigned. The operator enters dimensional and other data manually. The report number of a current report may be changed to the next available report number by clicking on the new report number button 58. The inspection software automatically saves the inspection report to a number that is one higher than the highest report number in the directory. The go back button 60 is depressed to return to the main menu 10. Clicking on the cancel buttons 17,61 closes all menus and stops entry of further data.

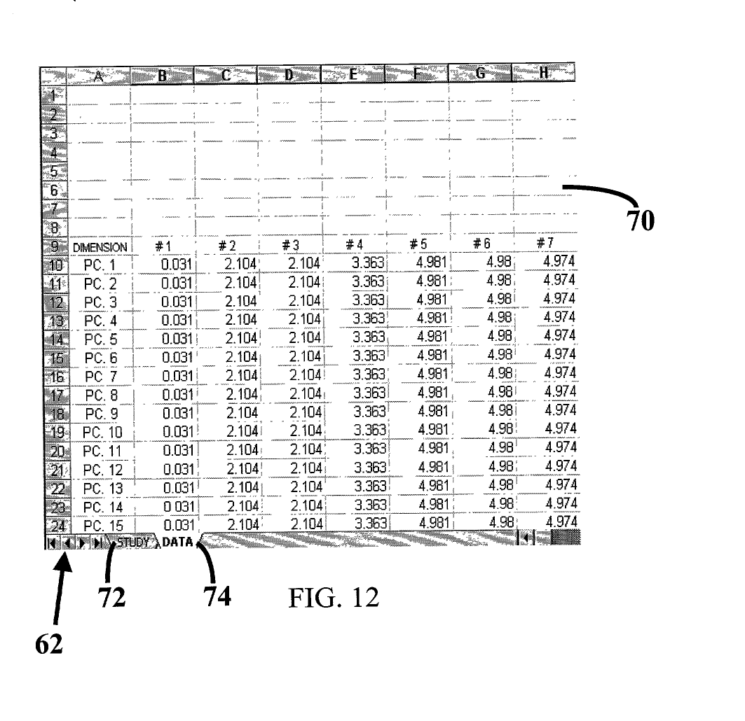

With reference to FIGS. 11 and 12, a capability study spread sheet 62 may be created by clicking on the capability study button 14. The inspection software will open a capability study menu 64 shown in FIG. 4. Next, an open a new study button 66 is clicked. The capability study spread sheet 62 preferably comes up in Microsoft Excel. The inspection software provides two spread sheet formats for the capability study data. The first format is a study page 68 which is shown in FIG. 11. The second format is a data page 70 which is shown in FIG. 12. The inspection software allows toggling between the study page 68 and the data page 70 by clicking either the study page tab 72 or the data page tab 74 on the bottom left corner of the capability study spread sheet 62. The operator exits the study page 68 or the data page 70 by clicking file on the menu and then close just like any other windows program.

The data page 70 preferably contains a column A which is reserved for the placement of piece part numbers. The succeeding columns are reserved for a particular dimension of the piece parts. Preferably, cell 9A contains the title “DIMENSION,” cell 9B contains the title “#1”, cell 9C contains the title “#2,” and so forth. The dimensions of each piece part are listed sequentially according to the titles in row 9. Each piece part is listed in numeric order starting in row 10.

The study page 68 is preferably identified by filling in the cell for customer, part number, and revision. Area for inserting a company logo is formed on in an upper left corner of the capability study spread sheet 62. The study page 68 preferably contains columns A and B which are reserved for the placement of titles providing statistical information about the part numbers disclosed on the data page 70. Preferably, the nominal print dimension is expressed in row 12, the upper tolerance of the dimension in row 13, the lower tolerance of the dimension in row 14, the specified upper tolerance in row 16 and the specified lower tolerance in row 17. Cells in row 12 and 13 are filled in manually by an operator. Cells in row 14 may be calculated by a specific formula or overwritten by an operator to be consistent with the blueprint.

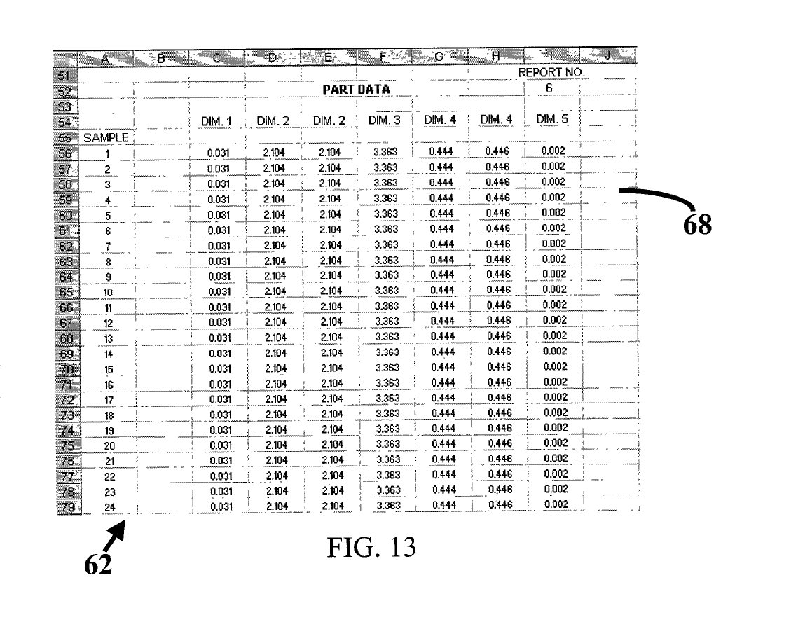

The numbers in rows 16 and 17 are calculated using the information in rows 12-14. The maximum measured value, minimum measured value, and range are preferably assigned rows 25-27. The maximum measured value, minimum measured value and range derive their values from the respective columns 56 to the last data entry in that column as seen in FIG. 13. The following statistical calculations are preferably listed in row 19 and so on: average, sigma, average+3 sigma, average−3 sigma, six sigma, CP, CPK, and any other appropriate calculation method.

Each row which has a statistical formula title contains a function that calculates that particular statistical formula. The function is contained in each cell in the row which is populated by a dimension of the piece part. Each dimension of every piece part entered into the capability study spread sheet 62 is calculated by the function. Preferably, the inspection software automatically inserts the present date in cell D4 of the study page 68 and a consecutive report number. The inspection software looks at the saved files and adds 1 to the last file saved and inserts the value in cell H2 of the study page 68. With reference to FIG. 13, the data found on the data page 70 is preferably listed at a bottom of the study page 68.

Additional parts may be added to a capability study spread sheet 68 by first clicking on the Excel macro button and then clicking the button 14. The capability study menu 64 will appear and the operator then clicks on the additional parts button 67. The inspection report generating software will open a previously saved text file generated by a Coordinate Measuring Machine (CMM). The inspection software will remove excess lines and text from the CMM text file not required by the capability study spread sheet; then rearrange the values of the dimensions according to the numbers designated on a blue print of a piece part. The data from the additional piece part will be copied and pasted into on the data page 70. Statistics formulas found on the study page 68 will be automatically updated with the data from the additional piece part.

A closed report may be opened by clicking on the closed report button 69. The inspection software will prompt the operator to enter the report number into a pop-up window similar to that shown in FIG. 3. The operator may then add more parts to the capability study. An operator may return to the main menu 10 from the capability study menu 64 by clicking the go back button 76. Clicking the cancel button 78 will stop program operation.

The inspection report generating software may be installed on a CMM computer, or data file(s) from the CMM computer may be transferred to a stand alone computer where the inspection report generating software is installed. Dimensions or tolerances of the piece part drawing or blue print may be referred to as “expected” dimensions or “expected” tolerances.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of converting a coordinate measuring machine data file for at least one piece part into a report comprising the steps of:
(a) reading at least one coordinate measuring machine data file;
(b) extracting a plurality of expected dimensions, expected tolerances, and measured dimensions from each said at least one coordinate measuring machine data file;
(c) displaying said plurality of expected dimensions, expected tolerances, and measured dimensions into columns and rows with titles describing each said expected dimension, expected tolerance, and measured dimension in said report;
(d) providing the capability of entering geometric tolerance frames into a report containing said dimensions and tolerances; and
(e) providing the capability to edit said report.

2. The method of converting a coordinate measuring machine data file for at least one piece part into a report of claim 1, wherein:
said report capable of being viewed in a spread sheet program.

3. The method of converting a coordinate measuring machine data file for at least one piece part into a report of claim 1, further comprising the steps of:
(f) providing the capability to display a high and low range for multiple readings of the same dimension in said report.

4. The method of converting a coordinate measuring machine data file for at least one piece part into a report of claim 1, further comprising the steps of:
(f) providing the capability to enter at least one additional piece part into said report.

5. The method of converting a coordinate measuring machine data file for at least one piece part into a report wherein:
said method of converting a coordinate measuring data file being created in a visual basic programming language.

6. A method of converting a coordinate measuring machine data file for at least one piece part into a report comprising the steps of:
(a) reading at least one coordinate measuring machine data file;
(b) extracting a plurality of expected dimensions, expected tolerances, and measured dimensions from said coordinate measuring machine data file;
(c) displaying said plurality of expected dimensions, expected tolerances, and measured dimensions into columns and rows with titles describing each said expected dimension, expected tolerance, and measured dimension; and
(d) providing statistical analysis for the measured dimensions of at least two piece parts, providing titles of the type of statistical analysis calculated.

7. The method of converting a coordinate measuring machine data file for at least one piece part into a report of claim 6, further comprising the steps of:
(e) providing the capability to edit said report.

8. The method of converting a coordinate measuring machine data file for at least one piece part into a report of claim 6, wherein:
said report capable of being viewed in a spread sheet program.

9. The method of converting a coordinate measuring machine data file for at least one piece part into a report of claim 6, further comprising the steps of:
(e) providing the capability to enter at least one additional piece part into said report.

10. The method of converting a coordinate measuring machine data file for at least one piece part into an operator defined display wherein:
said method of converting a coordinate measuring data file being created in a visual basic programming language.

11. A method of converting a coordinate measuring machine data file for at least one piece part into a report comprising the steps of:
(a) reading at least one coordinate measuring machine data file;
(b) extracting a plurality of expected dimensions, expected tolerances, and measured dimensions from each said at least one coordinate measuring machine data file;
(c) displaying said plurality of expected dimensions, expected tolerances, and measured dimensions into columns and rows with titles describing each said expected dimension, expected tolerance, and measured dimension in said report;
(d) providing the capability of entering geometric tolerance frames into a report containing said dimensions and tolerances;
(e) providing statistical analysis of the measured dimensions of at least two piece parts, providing titles of the type of statistical analysis calculated; and
(f) providing the capability to edit said report.

12. The method of converting a coordinate measuring machine data file for at least one piece part into a report of claim 11, wherein:
said report capable of being viewed in a spread sheet program.

13. The method of converting a coordinate measuring machine data file for at least one piece part into a report of claim 11, further comprising the steps of:
(g) providing the capability to display a high and low range for multiple readings of the same dimension in said report.

14. The method of converting a coordinate measuring machine data file for at least one piece part into a report of claim 11, further comprising the steps of:
(g) providing the capability to enter at least one additional piece part into said report.

15. The method of converting a coordinate measuring machine data file for at least one piece part into a report of claim 11 wherein:
said method of converting a coordinate measuring data file being created in a visual basic programming language.
